(19) United States
(12) Patent Application Publication
(10) Pub. No.: US 2015/0202819 A1
(43) Pub. Date: Jul. 23, 2015

(54) BLOW-MOLDING MOLD

(71) Applicant: FTS CO., LTD., Toyota (JP)

(72) Inventors: Yumi NAKANE, Toyota (JP); Koji Sugiura, Toyota (JP); Toshiaki Asahara, Toyota (JP)

(73) Assignee: FTS CO., LTD., Toyota (JP)

(21) Appl. No.: 14/158,397

(22) Filed: Jan. 17, 2014

(51) Int. Cl. B29C 49/48

(52) U.S. Cl. CPC B29C 49/4802; B29C 2049/4805; B29C 2049/4879

(57) ABSTRACT

A blow-molding mold to be used for forming a tank by blow-molding comprises an outer wall of the tank having two neighboring tank projection portions and a tank recessed portion formed between the two neighboring tank projection portions, the blow-molding mold including a first mold recessed portion formed inside surface side which forms a cavity and forming one of the two neighboring tank projection portions, a second mold recessed portion forming the other of the two neighboring tank projection portions and a mold projection portion provided between the first and the second mold recessed portions and forming the tank recessed portion, wherein a projection surface recessed portion or a projection surface projection portion is formed at an area of an outer surface of the mold projection portion with which a parison is brought into contact.

### BACKGROUND OF THE INVENTION

1. Field of the Invention

This invention relates to a blow-molding mold used for forming a synthetic resin-made tank by blow-molding.

2. Description of Related Art

Recently, as a method for forming a synthetic resin-made tank, such as for example, forming a fuel tank for an automobile, a blow-molding method has been frequently used because of the easiness of forming a hollow body. As shown in FIG. 13 of the attached drawings, under such method for forming by blow-molding, first a molten thermoplastic synthetic resin parison 8 is formed to be of cylindrical shape, the cylindrically shaped parison 8 is extruded from the nozzle 9, the extruded parison 8 is sandwiched and held by the blow-molding mold 120 and then the compressed air is blown into the parison 8 to manufacture a fuel tank used for an automobile. (For example, see Patent Document 1).

In most cases, the fuel tank is formed with a plurality of concave-convex portions on the outer wall in order to agree the shape thereof with the vehicle body, to strength the rigidity of the tank per se, or to attach some parts thereon. In such case, as shown in FIG. 13, the blow-molding mold 120 is provided with a first mold recessed portion 121 and a second mold recessed portion 122 and a mold projection portion 123 formed between the first mold recessed portion 121 and the second mold recessed portion 122 to form the concave-convex portions on the outer wall of the tank to be formed.

### DOCUMENT LIST OF RELATED ART

### Patent Document

Patent Document 1: JP2011-168072

### DISCLOSURE OF INVENTION

When the blow-molding is carried out using the blow-molding mold 120 shown in FIG. 13, as shown in FIG. 14, the air is blown into the parison 8 by closing the mold 120. Then the parison 8 is first brought into contact with a mold projection portion surface 124 of the mold projection portion 123 of the blow-molding mold 120 at the area “A” indicated in FIG. 14.

Thereafter, the compressed air is still continuously blown into the inside of the parison 8 keeping the mold 120 to be under closed state. The parison 8 is pushed against the first and the second mold recessed portions 121 and 122 and the mold projection portion surface 124 to be shaped to have an outer profile correspond to the outer profile along the mold recessed portions 121 and 122 and the projection portion surface 124.

If the recess of the first mold recessed portion 121 is wider than the recess of the second mold recessed portion 122, the portion of the parison 8 corresponding to the second mold recessed portion 122 is pulled towards the first mold recessed portion 121 side and accordingly, the area indicated by “A” in FIG. 14 is displaced towards the first mold recessed portion 121 side until it reaches at the area “A” indicated in FIG. 15. Therefore, the thickness of the parison 8 at a portion which contacts with the second mold recessed portion 122 becomes thinner than the thickness of the parison 8 at a portion which contacts with the first mold recessed portion 121. This may lead to a reduction of rigidity of the tank wall.

In order to assure a required thickness at the portion of the parison 8 contacting with the second mold recessed portion 122, the entire thickness of the parison 8 may be increased. However, in such case, the weight of the tank as a whole becomes increased and once the parison 8 contacts with the mold projection portion 123, the temperature of the area of the contact (“A” area in FIG. 14) drops and when the position is deviated, a synthetic resin surface of the tank generates wrinkles which again reduces the rigidity and which also reduces the visual quality.

This invention was made considering the above issues of the related art and it is an object of the invention to provide a blow-molding mold for a tank the thickness of which is formed to be uniform and the outer surface of which is formed to be of no wrinkles.

The blow-molding mold associated with a first aspect of the invention to solve the above issues is characterized in that the blow-molding mold to be used for forming a tank by blow-molding includes an outer wall of the tank having adjacently provided at least two neighboring tank projection portions and a tank recessed portion formed between the two neighboring tank projection portions. The blow-molding mold of the invention includes a first mold recessed portion formed inside surface side which forms a cavity and forming one of the adjacently provided two neighboring tank projection portions, a second mold recessed portion forming the other of the adjacently provided two neighboring tank projection portions and a mold projection portion provided between the first and the second mold recessed portions and forming the tank recessed portion, wherein a projection portion surface recessed portion or a projection portion surface projection portion is formed at an area of an outer surface of the mold projection portion with which a parison is brought into contact.

According to the first aspect of the invention above, since the outer wall of the tank has adjacently provided at least two neighboring tank projection portions and a tank recessed portion formed between the two neighboring tank projection portions, the rigidity of the outer wall of the tank can be improved by the tank projection portion and the tank recessed portion. Further, the tank can be shaped corresponding to a mating component to which the tank is attached and the tank can be appropriately formed to have a shape to agree with the shape of a component which is attached to the tank.

The blow-molding mold includes a first mold recessed portion formed inside surface side which forms a cavity and forming one of the adjacently provided two neighboring tank projection portions, a second mold recessed portion forming the other of the adjacently provided two neighboring tank projection portions and a mold projection portion provided between the first and the second mold recessed portions and forming the tank recessed portion. Accordingly, the blow-molding mold can be adapted to be formed to agree with the shape having concave-convex portions.

According to the invention, since the projection portion surface recessed portion or a projection portion surface projection portion is formed at an area of an outer surface of the mold projection portion with which a parison is brought into contact, the outer surface of the parison is held at the projection portion surface recessed portion or the projection portion surface projection portion thereby to keep the parison at the right place, not to be deviated during blow-molding operation. Thus, under the blow-molding for forming the tank with odd-even surface on the outer wall surface, the outer wall thickness can be equalized over the tank wall and generation of the wrinkles on the surface can be prevented.

According to a second aspect of the invention, the tank is a fuel tank for an automobile and the mold is a blow-molding mold for forming a fuel tank of an automobile.

According to the second aspect of the invention, since the mold is a blow-molding mold for forming a fuel tank of the automobile, a complicated profile or various profiles of the fuel tank can be shaped depending on the shape of the vehicle body to which the tank is installed or the shape of components or the shape of a cap or a hose which are attached to the tank.

According to a third aspect of the invention, the blow-molding mold includes the first and the second mold recessed portions, wherein a recess of one of the first and the second mold recessed portions is wider than the recess of the other of the first and the second mold recessed portions.

According to the third aspect of the invention, since the recess of one of the first and the second mold recessed portions is wider than the recess of the other of the first and the second mold recessed portions, the movement of the parison towards the mold recessed portion which recess is wider than the other is limited by the projection portion surface recessed portion or the projection portion surface projection portion to form a tank which has an even thickness and no wrinkle surface.

According to a fourth aspect of the invention, the blow-molding mold includes the projection portion surface recessed portion which is a single or a plurality of mold projection portion surface grooves formed at the mold projection portion.

According to the fourth aspect of the invention, since the projection portion surface recessed portion is a single or a plurality of mold projection portion surface grooves formed at the mold projection portion, the surface of the parison is engaged with the single or the plurality of mold projection portion surface grooves and the displacement of the parison is prevented by the projection portion to form a tank which has an even thickness and no wrinkle surface. The parison can be surely held or clamped by the plurality of mold projection portion surface grooves.

According to a fifth aspect of the invention, the blow-molding mold includes the projection portion surface recessed portion which is a single or a plurality of mold projection portion surface holes formed at the mold projection portion.

According to the fifth aspect of the invention, since the projection portion surface recessed portion is a single or a plurality of mold projection portion surface holes formed at the mold projection portion, the surface of the parison is engaged with the single or the plurality of mold projection portion surface holes and the displacement of the parison is prevented by the projection portion to form a tank which has an even thickness and no wrinkle surface.

According to a sixth aspect of the invention, the blow-molding mold includes the projection portion surface recessed portion which is a single mold projection portion surface bent groove with a circular-arc cross section formed at the mold projection portion.

According to the sixth aspect of the invention, since the projection portion surface recessed portion is a single mold projection portion surface groove formed at the mold projection portion, the parison can be strongly held by widening the width of the mold projection portion surface bent groove. Further, since the mold projection portion surface groove is formed to be of circular in cross section, the parison (outer wall of the tank) after the molding can be easily drawn out. The surface of the parison is engaged with the single mold projection portion surface groove and the displacement of the parison is prevented by the projection portion to form a tank which has an even thickness and no wrinkle surface.

According to a seventh aspect of the invention, the projection portion surface recessed portion is shaped with a finely formed odd and even (grained) design.

According to the seventh aspect of the invention, since the projection portion surface recessed portion is shaped with the finely formed odd and even design, the surface of the parison is engaged with the shaped with the finely formed odd and even design formed on the mold projection portion and the displacement of the parison is prevented by the projection portion to form a tank which has an even thickness and no wrinkle surface. Since the surface of the outer wall of the tank has finely grained (odd and even) surface, such outer surface design can improve the visual quality by reducing depth and the size of the concave-convex portion.

According to an eighth aspect of the invention, the blow-molding mold includes the projection portion surface projection portion which is a single or a plurality of mold projection portion surface protrusions formed at the mold projection portion.

According to the eighth aspect of the invention, since the projection portion surface projection portion is a single or a plurality of mold projection portion surface protrusions formed at the mold projection portion, the surface of the parison is engaged with the single or the plurality of mold projection portion surface protrusions and the displacement of the parison is prevented by the projection portion thereby to form a tank which has an even thickness and no wrinkle surface. The parison can be surely held by the plurality of mold projection portion surface grooves.

According to a ninth aspect of the invention, the blow-molding mold includes the projection portion surface projection portion which is a single or a plurality of columnar mold projection portion surface projection portions formed at the mold projection portion.

According to the ninth aspect of the invention, since the projection portion surface projection portion is a plurality of columnar mold projection portion surface projection portions formed at the mold projection portion, the surface of the parison is engaged with the plurality of columnar mold projection portion surface projections and the displacement of the parison is prevented by the projection portion thereby to form a tank which has an even thickness and no wrinkle surface. The parison can be surely held by the plurality of mold projection portion surface grooves.

According to a tenth aspect of the invention, the parison to be used is made from a high density polyethylene resin (HDPE) or a synthetic resin composed mainly by the high density polyethylene resin (HDPE).

According to the tenth aspect of the invention, since the parison to be used is made from a high density polyethylene resin (HDPE) or a synthetic resin composed mainly by the high density polyethylene resin (HDPE), a tank with high durability and rigidity can be formed.

According to the invention, the blow-molding mold includes a first mold recessed portion which forms one of two neighboring tank projection portions, a second mold recessed portion which forms the other of two neighboring tank projection portions and a molding projection portion positioned between the first and the second mold recessed portions forming a tank recessed portion at an inner surface side forming a cavity. Therefore, a blow-molding mold which can be shaped to have any desired concave-convex shaped outer profile corresponding to the shape of a tank.

According to the invention, since the projection portion surface recessed portion or the projection portion surface projection portion is formed at an area of the surface of the mold projection portion, with which the parison is brought into contact, the surface of the parison is supported by the projection portion surface recessed portion or the projection portion surface projection portion upon blow-molding process and the displacement of the parison is prevented by the projection portion thereby to form a tank which has an even thickness and no wrinkle surface.

### BRIEF DESCRIPTION OF THE ATTACHED DRAWINGS

Various aspects of this invention will become apparent to those skilled in the art from the following detailed description of the preferred embodiments, when read in light of the accompanying drawings, in which:

FIG. 1 is a perspective view of a fuel tank formed by using a blow-molding mold according to an embodiment of the invention;

FIG. 2 is an enlarged cross section view of an outer wall of the fuel tank according to the embodiment of the invention;

FIG. 3 is a cross section view of the blow-molding mold attached to a blow-molding machine showing an opened state of the blow-molding mold;

FIG. 4 is a cross section view of the blow-molding mold attached to the blow-molding machine showing a state that a pinch plate of the blow-molding mold is closed;

FIG. 5 is a cross section view of the blow-molding mold attached to a blow-molding machine showing a closed state of the blow-molding mold;

FIG. 6 is a cross section view of one side blow-molding mold according to the embodiment of the invention;

FIG. 7A is a partial enlarged cross section view of a portion of the mold projection portion of the first embodiment of the blow-molding mold according to the invention;

FIG. 7B is a partial enlarged front view of the portion of the mold projection portion of the first embodiment of the blow-molding mold according to the invention;

FIG. 8A is a partial enlarged cross section view of a portion of the mold projection portion of the second embodiment of the blow-molding mold according to the invention;

FIG. 8B is a partial enlarged front view of the portion of the mold projection portion of the second embodiment of the blow-molding mold according to the invention;

FIG. 9A is a partial enlarged cross section view of a portion of the mold projection portion of the third embodiment of the blow-molding mold according to the invention;

FIG. 9B is a partial enlarged front view of the portion of the mold projection portion of the third embodiment of the blow-molding mold according to the invention;

FIG. 10A is a partial enlarged cross section view of a portion of the mold projection portion of the fourth embodiment of the blow-molding mold according to the invention;

FIG. 10B is a partial enlarged front view of the portion of the mold projection portion of the fourth embodiment of the blow-molding mold according to the invention;

FIG. 11A is a partial enlarged cross section view of a portion of the mold projection portion of the fifth embodiment of the blow-molding mold according to the invention;

FIG. 11B is a partial enlarged front view of the portion of the mold projection portion of the fifth embodiment of the blow-molding mold according to the invention;

FIG. 12A is a partial enlarged cross section view of a portion of the mold projection portion of the sixth embodiment of the blow-molding mold according to the invention;

FIG. 12B is a partial enlarged front view of the portion of the mold projection portion of the sixth embodiment of the blow-molding mold according to the invention;

FIG. 13 is a cross section view of a conventional blow-molding mold showing the state that a pinch plate is closed;

FIG. 14 is a partial enlarged cross section view of the conventional blow-molding mold showing that a parison is in contact with a mold projection portion; and

FIG. 15 is a partial enlarged cross section view of the conventional blow-molding mold showing that a parison is pushed into a mold recessed portion.

### DETAILED DESCRIPTION OF THE PREFERRED EMBODIMENTS OF THE INVENTION

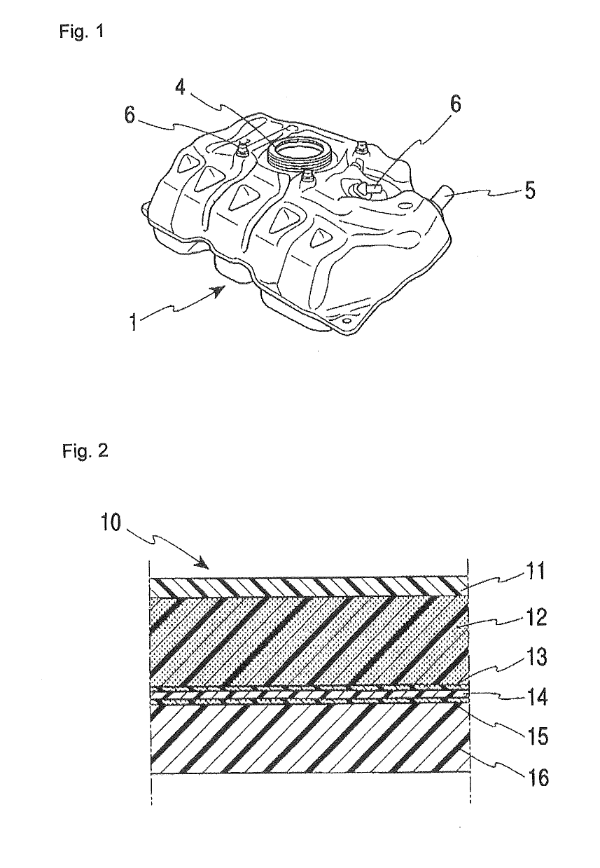

The preferred embodiments of the blow-molding molds according to the invention to be used for forming a fuel tank as an example of use will be explained hereinafter with reference to FIGS. 1 through 11 of the attached drawings. The blow-molding mold according to the embodiment can be used widely for any type of synthetic resin made fuel tank formed by blow-molding, not limiting to the synthetic resin made fuel tank explained herein.

As shown in FIG. 1, the fuel tank 1 formed by blow-molding according to the embodiment of the invention includes a number of concave-convex portions at the outer wall thereof. In other words, the fuel tank 1 is attached to a floor panel of the vehicle body at an underside surface thereof and the concave-convex portions are formed to correspond to the concave-convex portions of the underside surface of the floor panel of the vehicle body. At the same time, an upper surface of the fuel tank 1 is formed with an attaching hole 4 for attaching a pump unit to take the fuel pump (not shown) in or out. A fuel inlet 5 is provided at a side surface or an upper surface of the fuel tank 1 for supplying the tank with fuel through an inlet pipe (not shown). Further, a plurality of attaching hole 6 is formed on the upper surface of the tank 1 which is to be connected to a hose for removing fuel vapor generated inside of the tank. These portions make the outer wall 10 of the fuel tank 1 to be concave-convex.

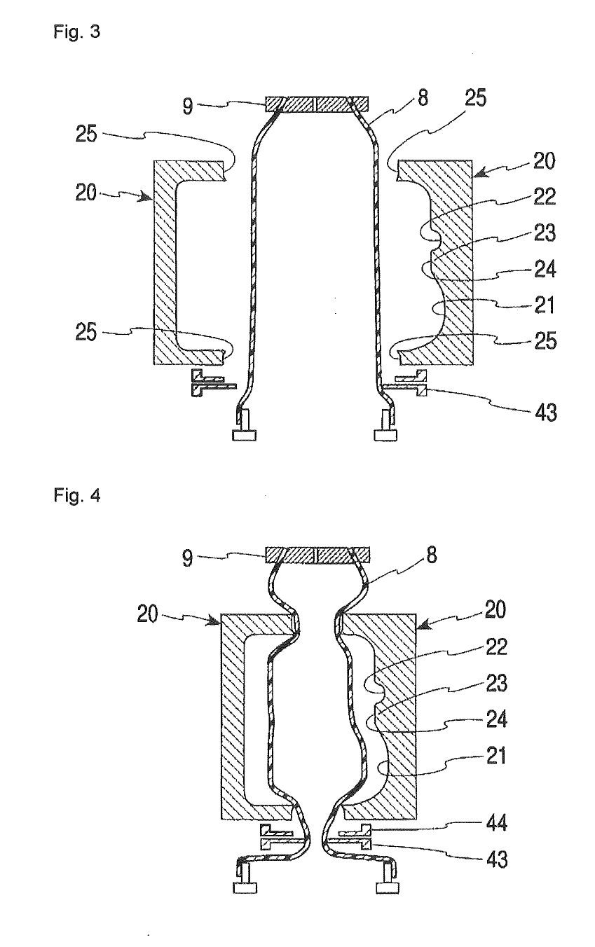

The fuel tank 1 of the invention is formed by blow-molding the parison 8, using the blow-molding mold 20 as shown in FIGS. 3 through 5. As particularly shown in FIG. 2, the outer wall 10 of the fuel tank 1 is preferably formed by layering a plurality of parisons 8. However, a single layered parison may be used to form the outer wall 10 of the tank 1. When the outer wall 10 is formed by a plurality of layers as shown in FIG. 2, the outer wall is formed by an outer surface layer 11, a main body layer 12, an external adhesive layer 13, barrier layer 14, internal adhesive layer 15 and an internal main body layer 16. According to the embodiments of the invention, the outer wall 10 is formed by the above six layered parison 8. However, the invention is not limited to the embodiments, and a parison formed by more than six layers may be used for forming the outer wall of the tank 1.

The outer surface layer 11 and the internal main body layer 16 are made from a thermal plastic synthetic resin which is highly impact resistant and has a high rigidity against the fuel oil and such synthetic resin is selected from polyethylene resin, polyamide resin or polyester resin. By thus forming, the outer surface layer 11 and the internal main body layer 16 have sufficient rigidity and even the layers are exposed to the fuel oil, the rigidity is not deteriorated and by strengthening the fuel tank, the impact resistance can be secured. Further, by covering the main body layer with the outer surface layer 11 which is high in rigidity, the main body layer 12 which is low in rigidity can be protected. The outer surface layer 11 may include a pigment, such as a carbon black pigment. As the polyethylene resin, it is preferable to use high density polyethylene resin (HDPE). It is noted here that when a tank other than the fuel tank 1 is used for this invention, the types and kinds of the resin to be used may be appropriately selected depending on the use thereof.

Next, the blow-molding mold 20 used for the method for manufacturing the fuel tank 1 according to the blow-molding process of the invention will be explained with the first to sixth embodiments with reference to FIGS. 3 through 12. First blow-molding using the blow-molding mold 20 according to the invention will be explained with reference to FIGS. 3 through 5 will be explained.

As shown in FIG. 3, first, the blow-molding mold 20 is disposed under the nozzle 9. The mold 20 is in open state. Then the parison 8 is lowered from the nozzle 9 and guided to be positioned inside the blow-molding mold 20. The parison 8 is not yet contacted with the inner surface (surface which forms the mold cavity) of the mold 20 under this state.

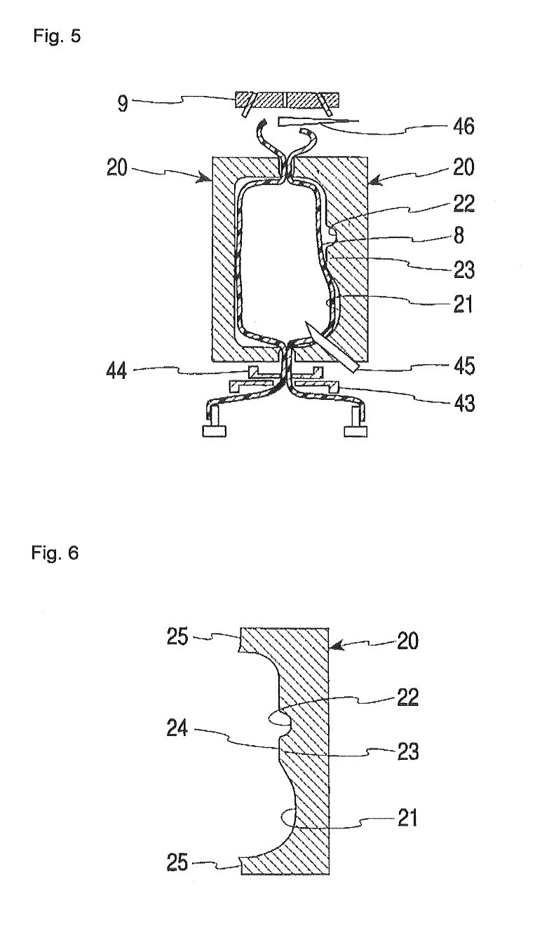

Then, as shown in FIG. 4, the opened state blow-molding mold 20 is gradually closed and the pinch plate 43 is slidably moved to pinch or hold the lower end of the parison 8. The pinch plate 43 may be provided at both upper and lower sides of the mold 20. Thereafter, as shown in FIG. 5, another pinch plate 44 is slidably moved to close the opening of the parison 8 and at the same time the blow-molding mold 20 is closed and the parison 8 is cut by a slider cutter 46.

The parison 8 is brought into contact with a mold projection portion 23 projecting from the inner surface of the mold 20. As shown in FIG. 6, the inner surface of the blow-molding mold 20 is formed with a plurality of concave-convex portions corresponding to the concave-convex portions of the outer wall 10 of the tank 1. The inner surface of the mold 20 is formed with a widely provided first mold recessed portion 21, a second mold recessed portion 22 which width is smaller than the first mold recessed portion 21 and a mold projection portion 23 provided between the first and the second mold recessed portions 21 and 22 and projecting from the inner surface towards the inside. The outer surface 24 of the mold projection portion 23 with which the parison 8 is in contact is formed with a plurality of projection portion surface recessed portions or projection portions according to the later explained first to sixth embodiments.

Next, the mold contact surfaces 25 formed on the periphery of the blow-molding mold 20 are mutually brought into contact with each other to close the mold 20. Then the air is blown into the inside of the parison 8 from the air nozzle 45 as shown in FIG. 5 to push the outer surface of the parison 8 against the inside wall of the mold 20 so that the parison 8 may be fully held on the first mold recessed portion 21 and the second mold recessed portion 22 thereby to form the fuel tank 1. Thereafter, the blow-molding mold 20 is opened and the fuel tank 1 is taken out from the mold 20.

The deviation or displacement of the parison 8 relative to the mold 20 can be prevented the recessed portions or the projection portions formed on the outer surface of the mold projection portion 23. The parison 8 is not pulled towards the widely provided first mold recessed portion 21 side by the engagement with the recessed or the projected portions provided on the surface of the outer surface of the mold projection portion 23 to prevent the parison portion on the first mold recessed portion 22 from becoming thinner. Accordingly, the thickness of the outer wall of the fuel tank 1 is not deviated and is formed to be even.

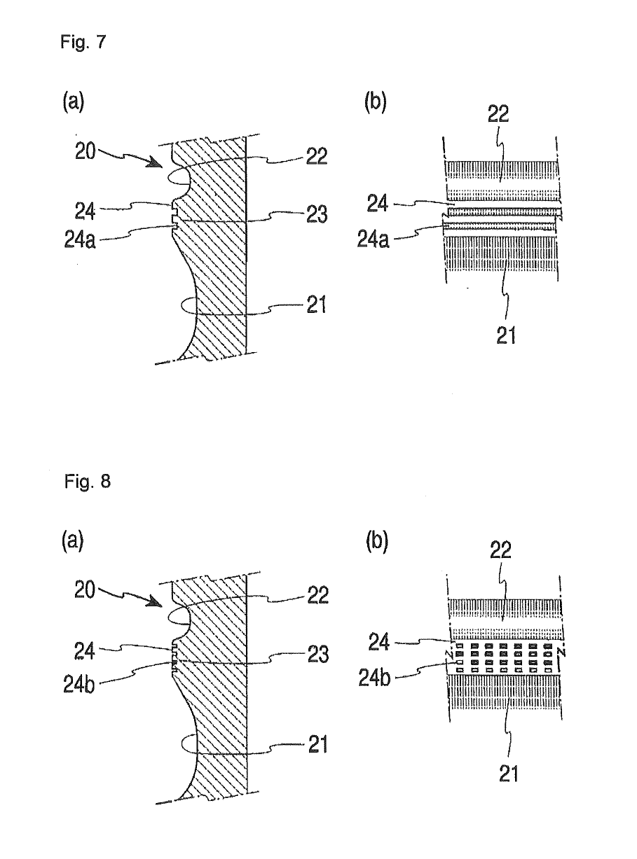

Next, the first embodiment of the projection portion surface recessed portions or the projection portion surface projection portion formed on the outer surface of the mold projection portion 23 will be explained with reference to FIGS. 7A and 7B. according to this first embodiment, as shown in FIGS. 7A and 7B, the outer surface 24 of the mold projection portion 23 is provided with two mold projection portion surface grooves 24a extending in a lateral direction relative to the first and the second mold recessed portions 21 and 22, as the projection portion surface recessed portions. According to the embodiment, the number of grooves 24a may be one or more than two. The depth of the groove is about 0.1 to 2.5 mm and the width thereof is about 0.1 to 5.0 mm. The length in a longitudinal direction extends over the entire surface of the mold projection portion surface 24 or may be provided at a portion thereof.

When the parison 8 is brought into contact with the mold projection portion surface 24 and pushed, the air is blown into. Since the parison 8 is still under melted state, the parison is enter into the grooves 24a of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22. Further, the parison 8 the temperature of which is dropped due to the contact with the surface 24 of the mold, is not deviated from the surface 24 of the mold projection portion 23 and is formed to be a tank with no wrinkles on the outer surface.

Next, the projection portion surface recessed portion or the projection portion surface projection portion formed on the outer surface 24 of the mold projection portion 23 according to the second embodiment will be explained hereinafter with reference to FIGS. 8A and 8B. According to this second embodiment, as shown in FIGS. 8A and 8B, a plurality of mold projection portion surface holes 24b which forms the projection portion surface recessed portion is provided on the outer surface 24 of the mold projection portion 23. According to this second embodiment, the holes 24b of the surface 24 of the projection portion 23 are arranged to form seven lines, each line having four holes. However, it is noted that the number of holes and the arrangement may be suitably changed depending on the situation. The depth of the hole 24b is about from 0.1 to 2.5 mm and the width thereof is about from 0.1 to 5.0 mm in case of polygonal shape and the diameter or the longer diameter is about from 0.1 to 5.0 mm in case of a circular shape or an ellipse shape.

When the parison 8 is brought into contact with the mold projection portion surface 24 and pushed, the air is blown into. Since the parison 8 is still under melted state, the parison is enter into the holes 24b of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22. Further, the parison 8 the temperature of which is dropped due to the contact with the surface 24 of the mold is not deviated from the surface 24 of the mold projection portion 23 and is formed to be a tank with no wrinkles on the outer surface.

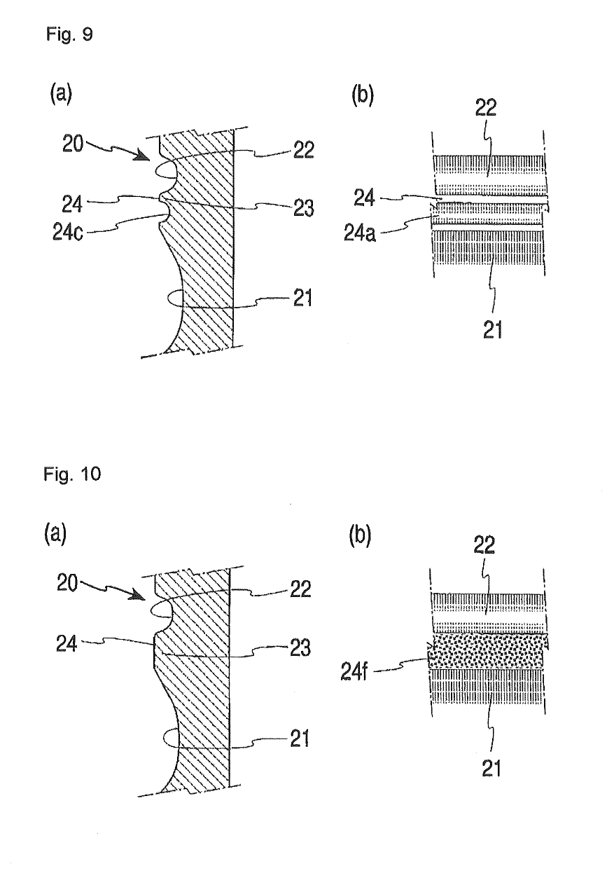

Next, the projection portion surface recessed portion or the projection portion surface projection portion formed on the outer surface 24 of the mold projection portion 23 according to the third embodiment will be explained hereinafter with reference to FIGS. 9A and 9B. According to this third embodiment, as shown in FIGS. 9A and 9B, a mold projection portion surface bent groove 24c which forms the projection portion surface recessed portion is provided on the outer surface 24 of the mold projection portion 23 in a lateral direction relative to the first and the second mold recessed portions 21 and 22. According to this third embodiment, the bent groove 24c of the surface 24 of the projection portion 23 is circular-arc in cross section in width direction. Since the groove 24c is arc shaped in cross section in width direction, it is easier for the parison 8 to enter into the bent groove 24c of the surface 24 of the projection portion 23. The depth of the bent groove 24c of the surface 24 of the projection portion 23 is about from 0.3 to 7 mm and the width thereof is about from 3 to 70 mm.

When the parison 8 is brought into contact with the mold projection portion surface 24 and pushed, the air is blown into. Since the parison 8 is still under melted state, the parison is enter into the bent groove 24c of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22. Further, the parison 8 the temperature of which is dropped due to the contact with the surface 24 of the mold is not deviated from the surface 24 of the mold projection portion 23 and is formed to be a tank with no wrinkles on the outer surface.

Next, the projection portion surface recessed portion or the projection portion surface projection portion formed on the outer surface 24 of the mold projection portion 23 according to the fourth embodiment will be explained hereinafter with reference to FIGS. 10A and 10B. According to this fourth embodiment, as shown in FIGS. 10A and 10B, a mold projection portion surface fine-grained surface 24f which forms the uneven concave-convex on the outer surface 24 of the mold projection portion 23. According to this fourth embodiment, the grained surface 24f of the projection portion 23 is finely formed. It is noted however, the depth of the grain or the density thereof may be suitably changed.

When the parison 8 is brought into contact with the mold projection portion surface 24 and pushed, the air is blown into. Since the parison 8 is still under melted state, the parison is enter into the fine-grained surface 24f of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22. Further, the parison 8 the temperature of which is dropped due to the contact with the surface 24 of the mold is not deviated from the surface 24 of the mold projection portion 23 and is formed to be a tank with no wrinkles on the outer surface. Further, since the surface 24f is finely grained and the unevenness is small, the outer appearance of the outer wall 10 of the tank 1 is attractively shaped.

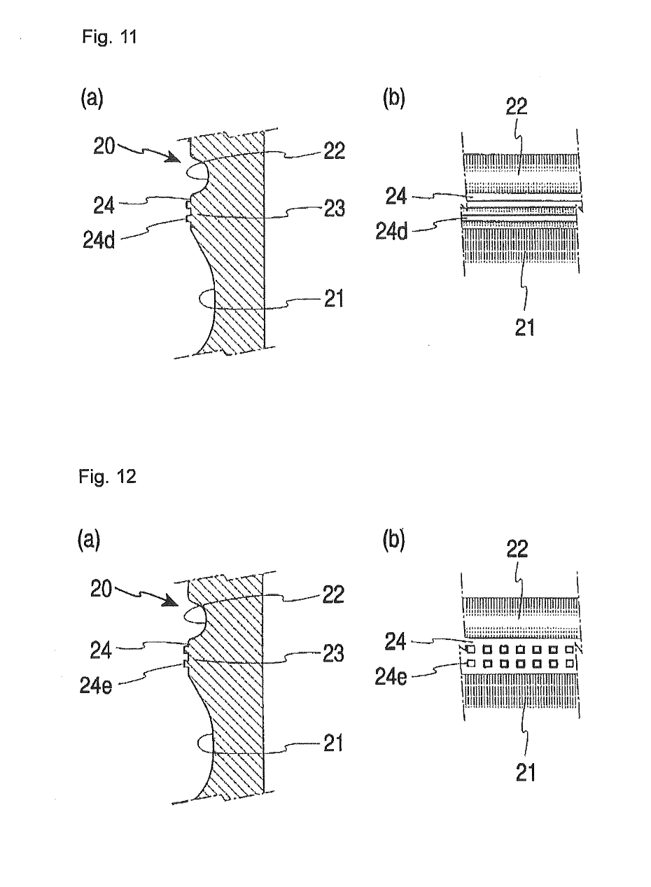

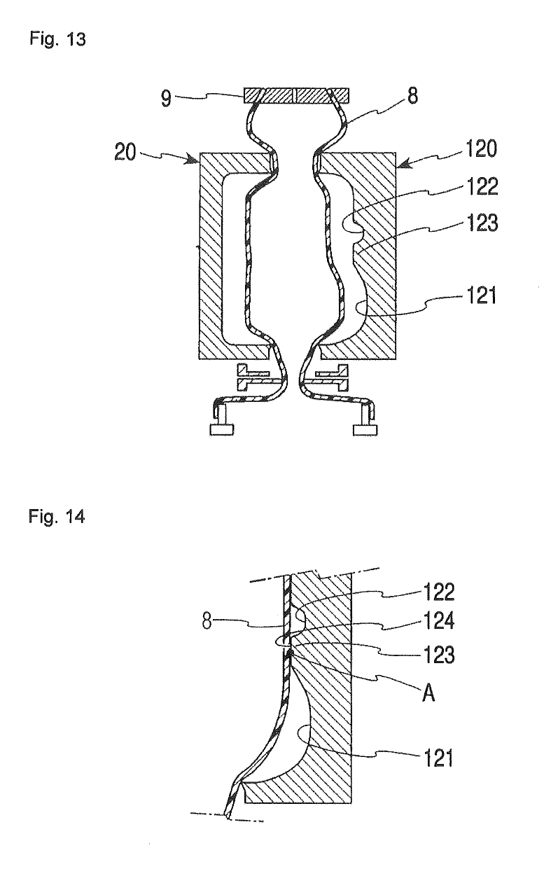

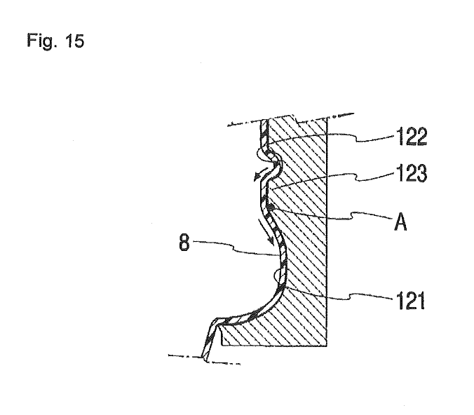

Next, the projection portion surface recessed portion or the projection portion surface projection portion formed on the outer surface 24 of the mold projection portion 23 according to the fifth embodiment will be explained hereinafter with reference to FIGS. 11A and 11B. According to this fifth embodiment, as shown in FIGS. 11A and 11B, two mold projection portion surface protrusions 24d formed on the surface 24 of the mold projection portion 23 in lateral direction relative to the mold first and the second recessed portions 21 and 22. According to this fifth embodiment, the nummore than two protrusions may be provided. The height of the protrusion 24d is about from 0.1 to 2.5 mm and the width thereof is about from 0.1 to 5.0 mm. the length in a longitudinal direction may be over the entire surface 24 of the mold projection portion 23 or may be a part of the entire length in the longitudinal direction.

When the parison 8 is brought into contact with the mold projection portion surface 24 and pushed, the air is blown into. Since the parison 8 is still under melted state, the parison is enter into the protrusions 24d of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22. Further, the parison 8 the temperature of which is dropped due to the contact with the surface 24 of the mold is not deviated from the surface 24 of the mold projection portion 23 and is formed to be a tank with no wrinkles on the outer surface.

Next, the projection portion surface recessed portion or the projection portion surface projection portion formed on the outer surface 24 of the mold projection portion 23 according to the sixth embodiment will be explained hereinafter with reference to FIGS. 12A and 12B. According to this sixth embodiment, as shown in FIGS. 11A and 11B, a plurality of mold projection portion surface projection portions 24e formed on the surface 24 of the mold projection portion 23. According to this sixth embodiment, the projection portions 24e of the surface 24 of the projection portion 23 are arranged to form seven lines, each line having two projection portions. However, it is noted that the number of projection portions and the arrangement thereof may be suitably changed depending on the situation. The height of the projection portion is about from 0.1 to 2.5 mm and the width thereof is about from 0.1 to 5.0 mm in case of polygonal shape and the diameter or the longer diameter is about from 0.1 to 5.0 mm in case of a circular shape or an ellipse shape.

When the parison 8 is brought into contact with the mold projection portion surface 24 and pushed, the air is blown into. Since the parison 8 is still under melted state, the parison is enter into the projection portions 24e of the mold projection portion surface 24 to have the outer surface of the parison 8 being clamped thereby. Thus, the parison 8 is secured on the surface 24 not to be deviated therefrom thereby to obtain the fuel tank 1 which has a uniform thickness outer wall 10 at a portion between the first and the second mold recessed portions 21 and 22.

Obviously, numerous modifications and variations of the present invention are possible in light of the above teachings. It is therefore to be understood that within the scope of the appended claims, the present invention may be practiced otherwise than as specifically described herein.

1. A blow-molding mold to be used for forming a tank by blow-molding, comprising:
an outer wall of the tank having adjacently provided at least two neighboring tank projection portions and a tank recessed portion formed between the two neighboring tank projection portions;
the blow-molding mold including a first mold recessed portion formed inside surface side which forms a cavity and forming one of the adjacently provided two neighboring tank projection portions, a second mold recessed portion forming the other of the adjacently provided two neighboring tank projection portions and a mold projection portion provided between the first and the second mold recessed portions and forming the tank recessed portion, wherein a projection surface recessed portion or a projection surface projection portion is formed at an area of an outer surface of the mold projection portion with which a parison is brought into contact.

2. The blow-molding mold according to claim 1, wherein the tank is a fuel tank for an automobile.

3. The blow-molding mold according to claim 1, wherein a recess of one of the first and the second mold recessed portions is wider than the recess of the other of the first and the second mold recessed portions.

4. The blow-molding mold according to claim 1, wherein the projection portion surface recessed portion is a single or a plurality of mold projection portion surface grooves formed at the mold projection portion.

5. The blow-molding mold according to claim 1, wherein the projection portion surface recessed portion is a plurality of mold projection portion surface holes formed at the mold projection portion.

6. The blow-molding mold according to claim 1, wherein the projection portion surface recessed portion is a single mold projection portion surface bent groove with a circular-arc cross section formed at the mold projection portion.

7. The blow-molding mold according to claim 1, wherein the projection portion surface recessed portion is shaped with a fine odd and even design.

8. The blow-molding mold according to claim 1, wherein the projection portion surface projection portion is a single or a plurality of mold projection portion surface protrusions formed at the mold projection portion.

9. The blow-molding mold according to claim 1, wherein the projection portion surface projection portion is a single or a plurality of columnar mold projection portion surface projection portions formed at the mold projection portion.

10. The blow-molding mold according to claim 1, wherein the parison to be used is made from a high density polyethylene resin (HDPE) or a synthetic resin composed mainly by the high density polyethylene resin (HDPE).
